(19) United States
(12) Patent Application Publication
(10) Pub. No.: US 2002/0129363 A1
(43) Pub. Date: Sep. 12, 2002

(54) System and method for visualizing user activity

(76) Inventor: Todd J. McGuire, Highlands Ranch, CO (US)

Correspondence Address: DORSEY & WHITNEY, LLP, SUITE 4700, 370 SEVENTEENTH STREET, DENVER, CO, 80202-5647, US

(21) Appl. No.: 09/909,617

(22) Filed: Jul. 20, 2001

Related U.S. Application Data
(60) Provisional application No. 60/274,793, filed on Mar. 9, 2001.

(51) Int. Cl. H04N 5/445; H04N 7/16

(52) U.S. Cl. 725/37; 725/9

(57) ABSTRACT

A system and process is provided which enables a Provider of a Web Site to obtain Log Data information relating to at least one user's utilization of the Web Site. In one embodiment, a log analyzer analyzes Log Data information and provides results thereof to a video reporter which generates a Movie (e.g., an audio, video or combined audio/video presentation) depicting a reenactment of the at least one user's utilization of the Web Site. The log analyzer may be directed by a filter and/or an anomaly collector (as controlled by the Provider via corresponding interface tools) to examine the Log Data for specific instances of information and/or anomalous conditions. Providers may also specify how, when, where, and why they are notified by the system when a Movie, an anomalous event or a pre-designated event occurs. Archival of Movies and statistical analysis of Movies and/or Log Data may also be accomplished.

### CROSS-REFERENCE TO RELATED APPLICATION

This application claims priority to U.S. Provisional Patent Application No. 60/274793 filed on Mar. 9, 2001, which is incorporated herein by reference.

### FIELD OF THE INVENTION

The present invention relates generally to the field of visualizing user activity. More specifically, the invention covers the use of visual movies to portray the usage patterns of a user of a web site, software application, or other electronic device.

### BACKGROUND OF THE INVENTION

As is commonly appreciated in the Internet community, suppliers of information services (for example, web sites, content providers, individuals, including, but not limited to, employees of an organization, managers, third-parties, executives, and anybody else, hereinafter collectively identified as “Providers”) often desire and need to obtain detailed information on how users utilize the various features and services provided by their sites. Such information is highly valuable in determining, for example: glitches in how a web site operates; usage patterns of users visiting a web site; what features and functions on a web site capture a user's attention and for how long; whether users are directed (either automatically or by choice) to advertisers' sites; determining how a user encountered a problem with a particular page on a site; and for other purposes. In short, Providers commonly desire to know and understand what a user does while visiting a site or using an application in order to optimize the visited site for maximum effectiveness.

Similarly, Providers of software applications (which may or may not be Internet enabled), electronic devices (including, for example, microwaves, televisions, VCRs, dishwashers, stoves, refrigerators, and other devices), and other devices also desire to be capable of receiving information on how a user accesses and utilizes a specific application or device. Such information is useful for determining, for example, warranty provisions (i.e., a warranty based upon a number of wash cycles utilized instead of a number of years), how a user utilizes an application or device, and what steps the user performed before they decided that a call to a service center was necessary in order to restore the application/device to an original configuration instead of its current, undesired configuration.

Thus, Providers desire to receive information on how a user accesses a web site, application, an electronic device, or other system. For purposes of simplicity only, such information shall collectively be referred to as “Log Data”, i.e., data which is suitably logged and identifies user activity. Further, for purposes of simplifying the following discussion of many of the features and functions of the present invention, web sites, applications, electronic devices, and any other device or system for which Log Data may be obtained are herein collectively referred in the singular and the plural as a “Web Site.”

Currently, various approaches are utilized to capture Log Data of user activity. One common approach utilizes web usability labs in which users are monitored as they utilize a Web Site. More specifically, these usability labs are often set up as an array of computers in a lab that is fitted with two-way mirrors and video recording devices. Sample Web Site users are assembled in a focus group and paid to interact with the Web Site being analyzed. Often the users are given specific tasks, such as “Purchase product X from the site” or “Locate product information on product Y”. The users may also be given random assignments, such as “Go to the site and just look around.”

Further, while the sample Web Site users are working with the Web Site being analyzed, all of their actions are being observed by the owners of the site through 2-way mirrors. In addition, the entire process is preferably recorded on video for follow-up analysis at a later date. While this process is often beneficial, it has significant drawbacks. One drawback is that it is very expensive, because a Provider has to rent the lab, assemble the test users, record the data and later analyze the data before any meaningful benefit may be obtained from the experiment. Further, this approach is very time consuming as it requires much advance planning and subsequent follow-up. Third, this approach may not result in the identification of the plusses and minuses inherent in any Web Site. Fourth, this approach does not provide a practical method for sharing user activity information throughout a large organization. Lastly, do to the preceding limitations and others, Providers generally are not able to utilize such an approach with enough frequency to test changes to a Web Site or other improvements, without repeating the entire process.

Another approach often utilized by Providers in order to assess user activity of a Web Site, is to perform statistical analysis of logging information generated during a visit by a user to the Web Site. As is common in the art, an entry in a “web log” is generated every time a user visits a Web Site or performs a function on the site, for example, the sending of a request and/or information to a server hosting a web application is recorded on the web log. An example of a web log is shown in FIG. 1. More specifically, the web log provides to a Provider an indication of: who visited the web site (usually designated by an IP address and an Internet Service Provider identifier); when they visited the site (in terms of date and time); for how long they visited a specific page on the site (as designated by the elapsed time between the initial downloading of a page and then a subsequent page); and what they visited on the site. In short, the web log provides Log Data indicating who, what, where, when, and how information on user activity vis-a-vis a web site. Additionally, it is commonly appreciated that similar information may also be generated for computer applications and virtually any electronic device (i.e., any Web Site) capable of creating user activity files (i.e., user logs).

Providers desiring information on the utilization of their Web Site often utilize the web log to identify statistical representations of how a site is utilized. Such information is commonly provided in the forms of charts and tables which are incapable of explaining or illustrating a user experience with a Web Site. While this approach eliminates many of the shortcomings of the web lab approach (in that it can be timely and is tremendously less expensive), the statistical approach also fails to provide Providers with specific illustrations of user usage information of a Web Site.

Therefore, a need exists for an simple, efficient, and effective approach for illustrating to Providers how users access a web site. Similarly, manufacturers of electronic devices and computer applications (which are not web based) need a simple efficient and effective approach for illustrating how a user actually utilizes a device, what function the device was performing when an anomalous condition occurred, and similar information.

### SUMMARY OF THE INVENTION

In a first embodiment, the present invention provides a system and method for analyzing web server logs (for example, HTTP logs) or other computer generated activity logs and converting the information contained on the logs, i.e., the Log Data, into a recreation of a user's accessing of a Web Site. The recreation may be provided as a visual, audio, audio/visual, or other presentation (hereinafter, a “Movie”) depicting what users were actually doing/seeing/hearing when they accessed a Web Site. More specifically, the Movie creates a reenactment of what the user was viewing on their screen (or the screen of a device, for example, a configuration screen for a television or a VCR connected to a video presentation device), hearing, or otherwise sensing as the user visited and/or utilized the Web Site.

The first embodiment also integrates Log Data with other known information about a user (if available) and presents that information in the context of the user session. For example, the Log Data may identify a user by an IP address, cookies, or other identifying devices which are then matched against a listing of users and IP addresses in order to specifically identify the user by name, location, and other demographic information. In this manner, the present invention enables Providers to more precisely identify who users are and relate more closely with their web “surfing” or other experience.

In order to create the Movie, especially when a large amount of Log Data is to be processed, the system preferably utilizes two filters: a custom filtering tool for creating a Movie based upon the occurrence of certain events in the Log Data; and an anomaly collector which examines key thresholds and then records a user session (i.e., creates a Movie) whenever a target event is triggered.

Additionally, the first embodiment incorporates various reporting and notification strategies, including real-time reporting, near real-time reporting, archival reporting, and statistical reporting. Each Movie is also suitably transferable to others via commonly available communications mechanisms including e-mail, server connections, and even U.S. mail delivery (for example, a video tape). Thus, the present invention may be utilized by any Provider or designee regardless of time and/or location.

The first embodiment provides a level of functionality similar to that provided by the web labs without the expense, time or system constraints inherent in the web lab approach. The removal of such constraints enables the Movie to be produced with a significant saving in time, space and money. For example, the present invention is not time dependent, since it may be accomplished (i.e., a Movie produced) at any time and with any desired frequency. Similarly, the Movie can be easily and (if desired) immediately shared with numerous employees in an organization including, for example, a Web Site design team, product managers, sales and marketing staff, executives, and others. The archiving of Movies in appropriate data storage locations is also provided.

Further, typical applications of the various embodiments of the present invention and the Movie creating capabilities thereof include, but are not limited to, visually displaying the usage patterns of: a web site user; a user at an Automated Teller Machine (ATM); a user of a software application (for example, Microsoft Word®); an information kiosk; a car dashboard; and an appliance (for example, a microwave oven wherein the Movie displays a representation of the microwave and a user selecting the various buttons provided thereon). It is to be appreciated that the present invention may be suitably configured to present a Movie of any usage of any device capable of recording such usage electronically.

Further, in another embodiment, audio recreations may also be created (i.e., audio “Soundtracks”). For example, a recreation of the stations selected by a person while driving in a car may be provided as a Soundtrack. In such an embodiment, the system records in the Log Data not only the stations selected by the user but also the time of day for such selection. The Log Data information is then matched with listings of radio broadcasts by date and time to recreate a Soundtrack of the user's listening experience. For example, by recalling precise segments of multiple station broadcasts from a recording of the live presentation, and matching such portions with the Log Data, a recreation of the actual listening experience for the user may be recreated. The Soundtrack would be highly valuable to producers of radio shows, advertisers, and “air-time” marketers, because a more precise identification may be obtained of those features and programs that attracted and retained a listening audience and those features and programs which drove the listening audiences to another station.

The features and functions of the present invention, as discussed with reference to the before mentioned embodiments is more fully described and disclosed with reference to the following drawing figures, detailed description section, and claims.

### BRIEF DESCRIPTION OF THE DRAWING FIGURES

FIG. 1 is a pictorial illustration of a prior art HTTP log.

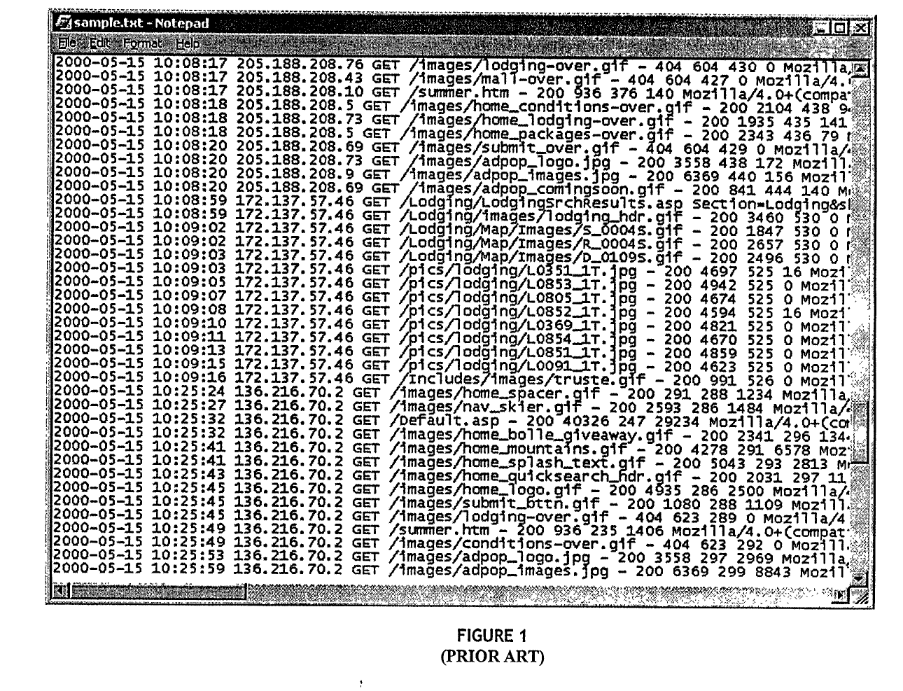

FIG. 2 is a pictorial representation of one screen of a Movie produced in accordance with a first embodiment of the present invention.

FIG. 3 is an illustrative example of a multi-screen presentation depicting two screens in half screen format specifically selected from four stamp sized screens for a Movie implemented according to a first embodiment of the present invention.

FIG. 3A is an enlargement of the first of the five stamp sized screens presented in FIG. 3, which has been selected for presentation on a full screen.

FIG. 3B is an enlargement of the second of the five stamp sized screens presented in FIG. 3, which has been selected for presentation on a full screen.

FIG. 3C is an enlargement of the third of the five stamp sized screens presented in FIG. 3, which has been selected for presentation on a full screen.

FIG. 3D is an enlargement of the fourth of the five stamp sized screens presented in FIG. 3, which has been selected for presentation on a fill screen.

FIG. 3E is an enlargement of the fifth of the five stamp sized screens presented in FIG. 3, which has been selected for presentation on a full screen.

FIG. 4 is an illustrative example of a result showing aggregate traffic distribution as calculated by one of the statistical sampling tools provided by the first embodiment of the present invention.

FIG. 5 is an illustrative example of an e-mail message delivering a Movie, the e-mail being sent by a system implementing the first embodiment of the present invention to a Provider subscribing to the system.

FIG. 6 is a exemplary screen shot of an interface provided for a custom filtering tool utilized in the first embodiment of the present invention.

FIG. 7 is system flow diagram identifying the system devices and process flow utilized in the first, web server based, embodiment of the present invention.

### DETAILED DESCRIPTION OF THE INVENTION

As discussed previously, a first embodiment of the present invention provides a system and process for generating and communicating to a Provider a Movie depicting how a user accessed a Web Site. The Movie is generated based upon Log Data collected by the Web Site, and contains information relating to how the user utilized a Web Site. The collecting of Log Data for Web Sites is well known in the art, such logging activities are not discussed herein. It is to be appreciated, however, that the first embodiment of the present invention may utilize any type of Log Data in creating a visual Movie and/or an audio Soundtrack (as appropriate) which illustrates a user's activity vis-a-vis a web site, an application, and/or a device (i.e., a “Web Site”). Further, as the multimedia features of the Internet and related applications and devices continue to expand it is to be appreciated that user interactivity with a Web Site will include both audio and video data (in addition to other forms of data including virtual reality, text, and graphics). As such, the first embodiment of the present invention is suitably configured to create multi-media presentations which encapsulate the user experience, as identified by Log Data files.

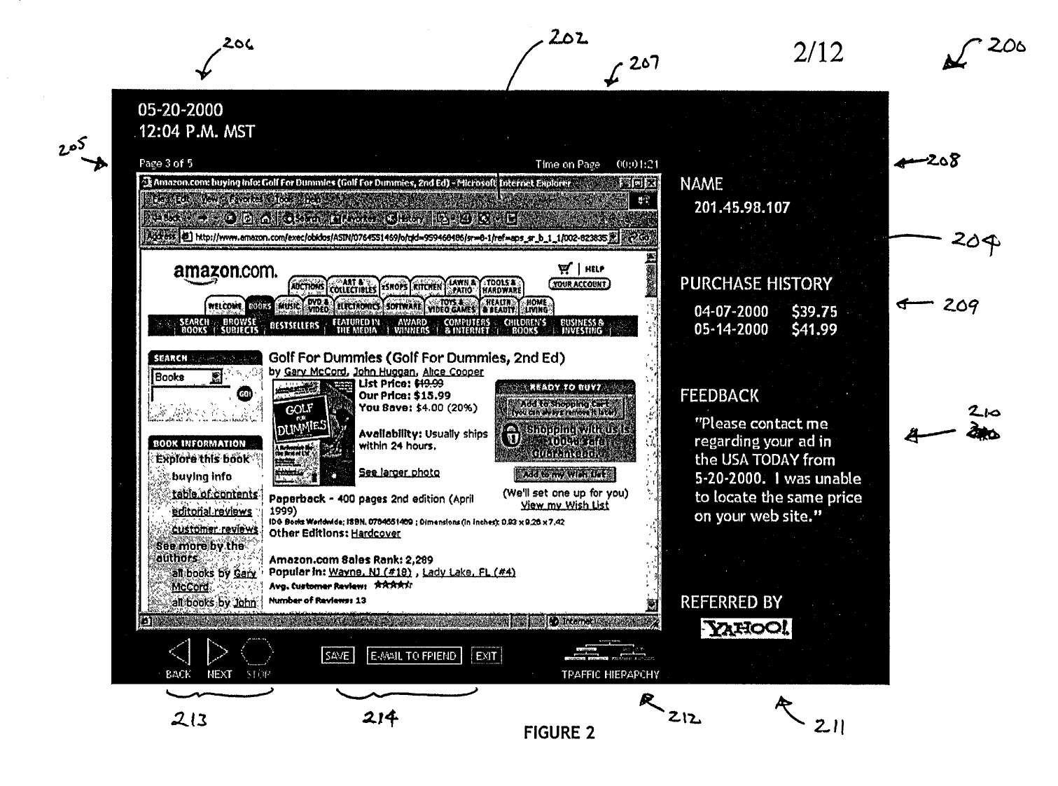

As shown in FIG. 2, one illustration of how the first embodiment of the present invention provides Movie illustrating a given user's experience with a Web Site, as recorded in a Log Data file, is shown. In this first embodiment, a screen 200 providing a still video image is presented of the user's experience. In this example, the experience occurred on a web site provided by Amazon.com®. As shown in the view field (202), the Movie portrays a user shopping and/or considering purchasing a book entitled “Golf for Dummies”. More specifically, the view field 202 presents to the Provider the specific screen and/or functions recorded on the Log Data file associated with the Amazon server for the user, during the specific session.

As shown, the screen 200 preferably contains a border area 204 in which various information relating to the user session is provided. For example, this screen 200 provides information relating to an indication of which screen in a series of screens the user accessed 205 (for example, a user jumping directly to the page 202 would have an indication of page 1 of X pages, whereas the user in this example viewed two other screens before reaching the displayed screen). Information is also provided identifying the date and time 206 of the user session and how long 207 the user was on the page. Demographic information about the user is also provided as indicated by the IP address for the user 208, and the purchase history for the user associated with the IP address 209. The purchase history and other user profiling information may be obtained via various well known profiling systems. For example, a cross-reference to a user profile stored in a separate database may be accomplished by utilizing a “cookie” communicated by the user's system to the server and suitably recorded in the Log Data.

Additionally, this screen 200 provides an identification of the referrer 211 which the user uses to reach and/or connect to the web site. Additionally, the log data may also be utilized, in certain circumstances, (for example, through reverse look-up techniques) to identify the ISP used to establish the Internet connection. Further, the referrer, if any, shows how the user found the web page displayed in field 202. User feedback information 210 is also provided by tying together any e-mails sent to the Provider from the user via the displayed web page. Additionally, user feedback information 210 may be pulled from e-mails associated with a customer's record, as maintained by the Provider.

This first embodiment of the present invention also provides a hierarchical traffic indication 212 designating how the user accessed the displayed web page. As shown, for this example, the user accessed the site from a level immediately below the top level, for example, a level probably dedicated to Books. The user then displayed two different web pages relating to Books, one of which is shown on the screen 200.

In addition to displaying the traffic hierarchy in a tree format, this indicator 212 also allows the Provider to jump to various other pages in the Movie, without having to rewind, restart, or view the Movie in sequential order. Since one embodiment of a Movie may include a collection of individual screens which may be presented at a full motion, slow motion, still, or other rate, the present invention enables the Provider to view the Movie at any point by suitably selecting that frame element associated with a specific segment. For example, by selecting the top most level of the highlighted hierarchy 212, the Provider can view the first page accessed by the user (i.e., the Movie effectively “rewinds” to the frame associated with that segment of the Movie). Thus, the tree hierarchy 212 enables the Provider to view any element of a user experience at any point along the experience.

Further, this screen 200 also provides sequential progression through the Movie at a desired rate, via the forward, backward, and stop buttons 213. Additionally, the screen can be saved, e-mailed, and exited by the corresponding buttons 214.

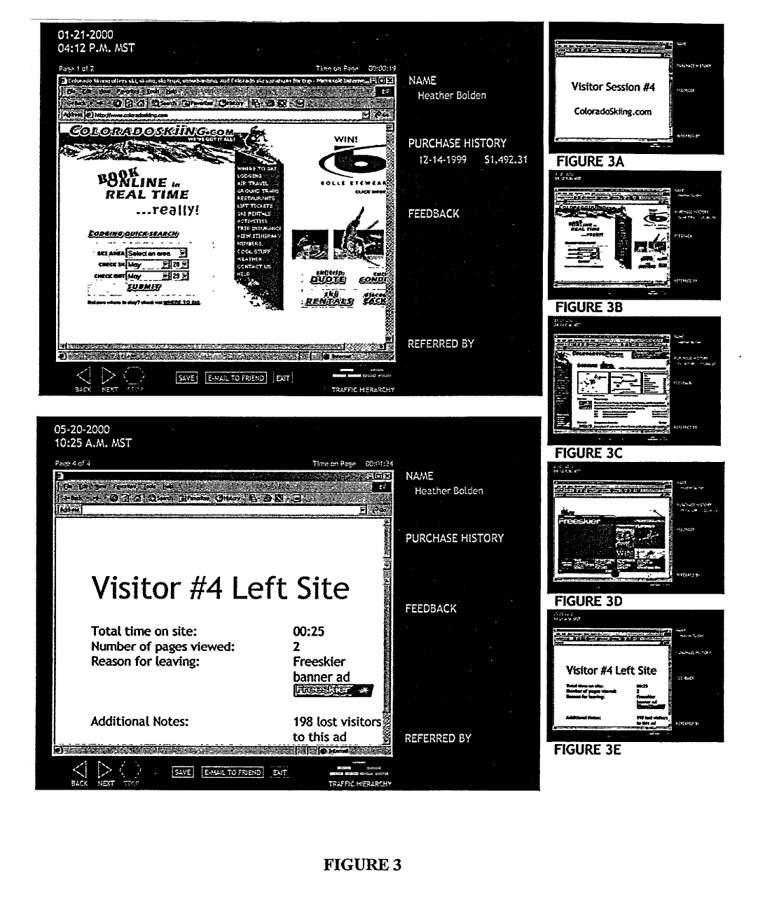

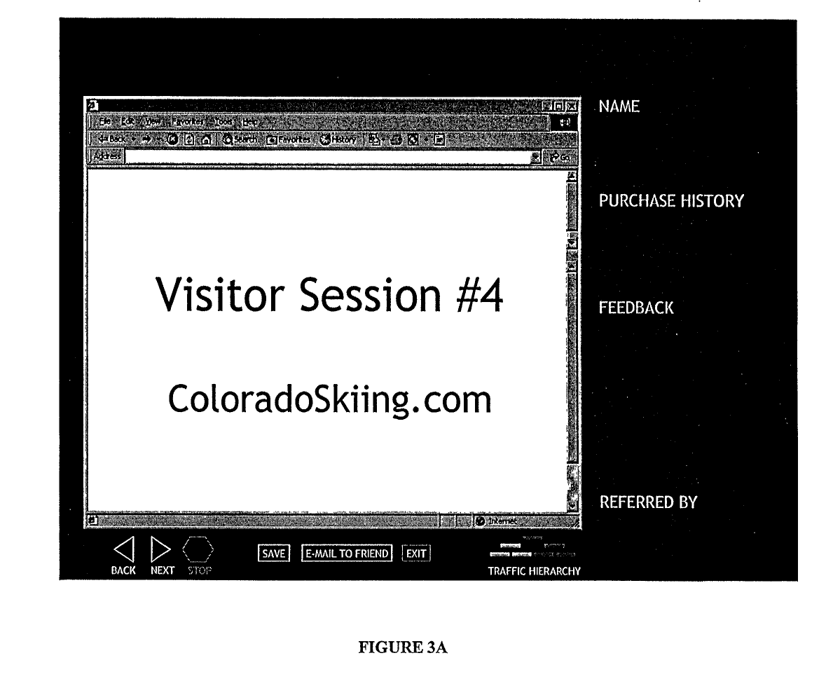

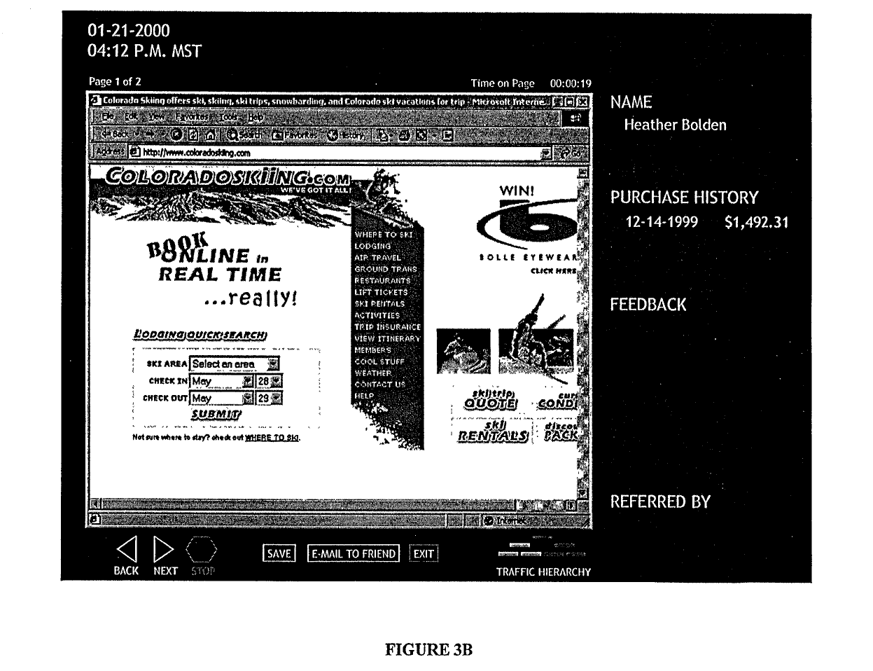

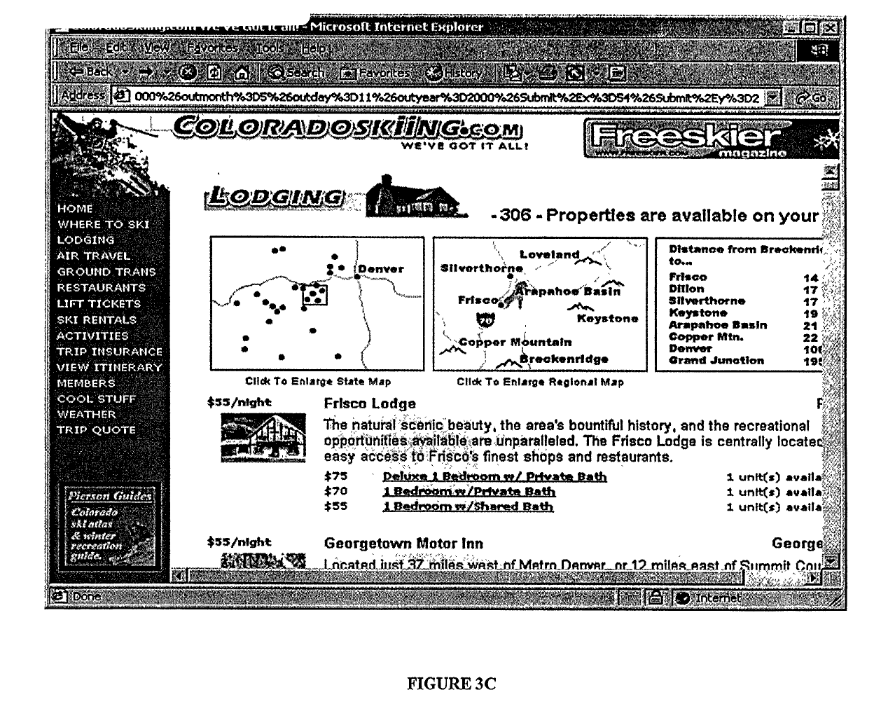

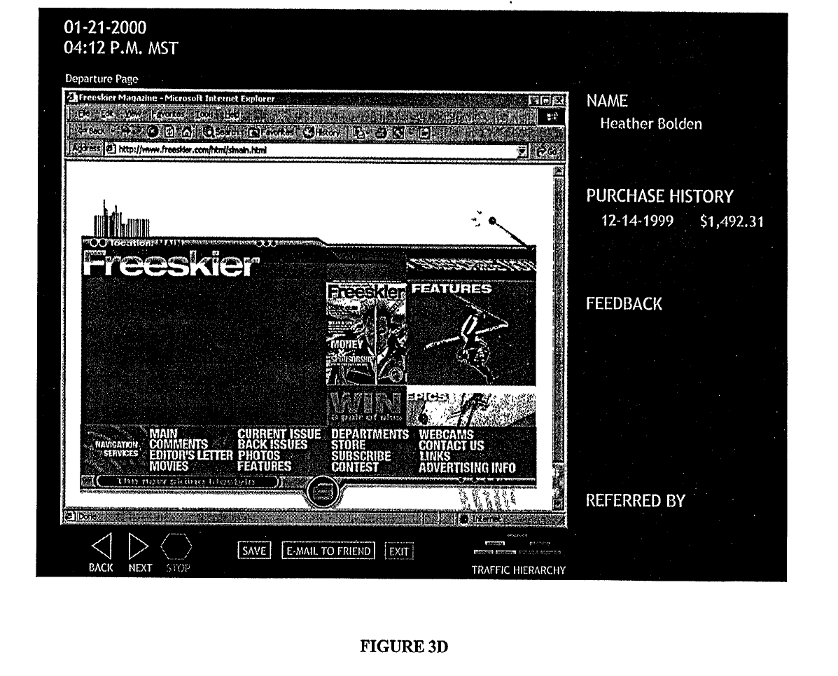

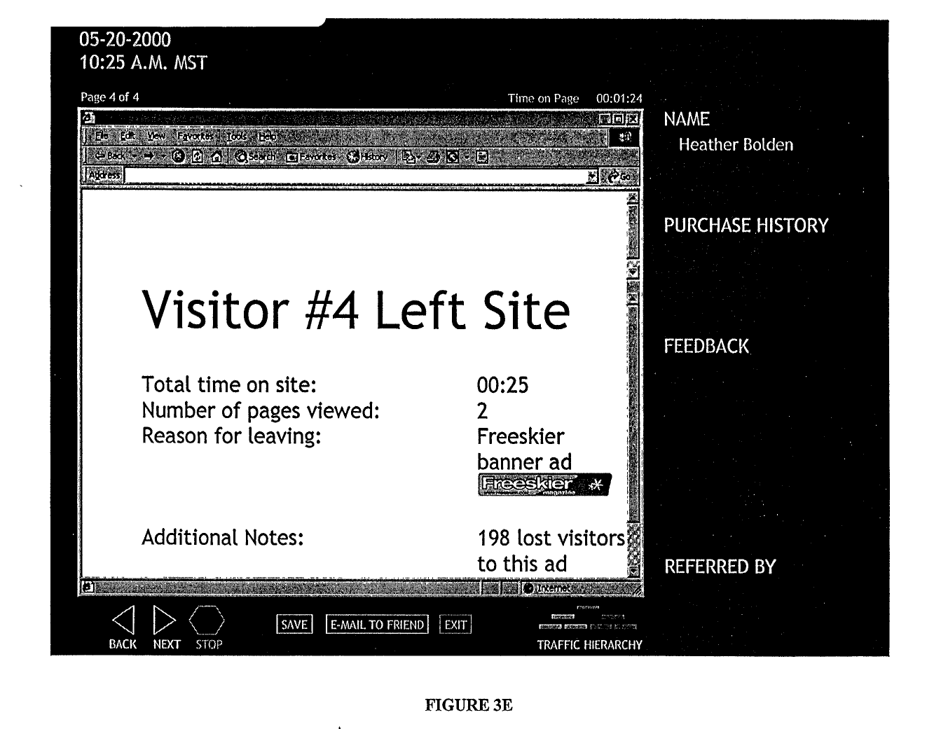

As shown in FIG. 3, the first embodiment of the present invention also allows the Provider to view multiple presentations of screens viewed by a user during a session with a Web Site. As shown, these multiple screens may be presented in half screen format, “stamp” sized, and in various other formats. Additionally, by suitably selecting any one of the “stamps,” the Provider may see full screen representations of the individual stamps, as shown in FIGS. 3A 3E. Further, as shown in FIG. 3A, a Movie preferably begins with a screen identifying the visitor session by number (for example, when multiple visitor sessions with a Web Site have been requested for production into a Movie) and by identifying the site contacted during the session (in this example, “ColoradoSkiing.com”).

Similarly, the first embodiment also creates an ending screen, as shown in FIG. 3E, in which summary information is presented about the user's experience with the previously identified Web Site. More specifically, this ending screen suitably identifies the total time the user spent on the site, the number of pages viewed, the reason for leaving the site (when known and/or deduced) and any additional information. For example, statistical information pertaining to how many users have left the site in the same manner as the current user may be presented. Additionally, it is to be appreciated that statistical information and other information may be presented on this ending screen or any other screen, as desired and specified by a Provider. The presentation of such additional information is preferably controlled by templates and settings designated by a Provider for a specific configuration of this embodiment of the present invention.

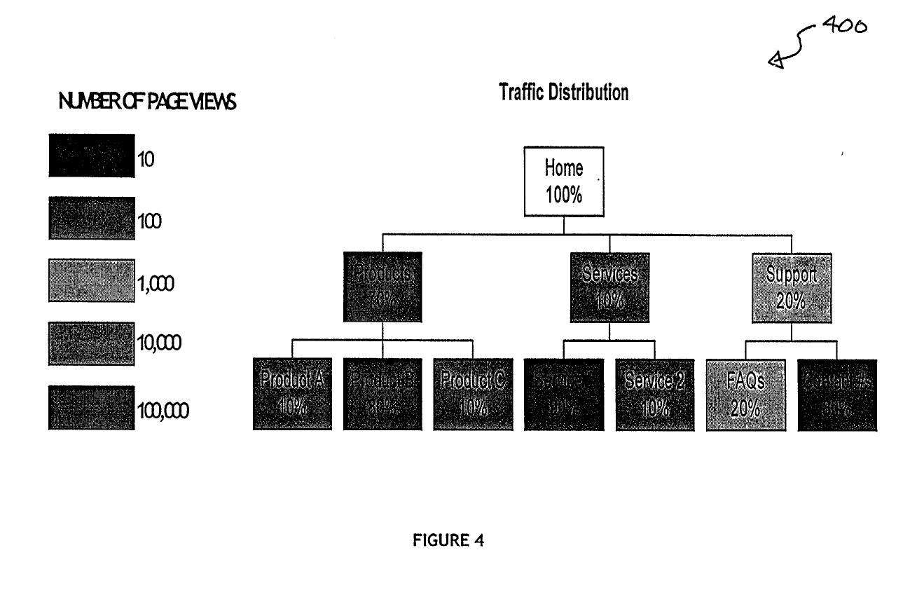

As mentioned previously, in addition to providing a Movie and other information relating to a user's experience with a Web Site various embodiments of the present invention are capable of providing other information related to the user's visit in a graphical or tabular format. An example of such information includes, but is not limited to, an aggregation of multiple user visits and a median user visit, as shown in FIG. 4 (wherein a listing of user visits by site and sub-pages is presented). This information is similar to the traffic hierarchy shown in FIG. 2, however, unlike the FIG. 2 presentation (wherein a single user's traffic pattern is displayed), the Traffic Distribution chart 400, as shown in FIG. 4, provides aggregate information on a plurality of user visits. The Traffic Distribution chart may also be suitably presented on any of the individual Movie screens (for example, those shown in FIGS. 3A-3E), and/or it may be presented by itself. Other statistical tabulations and information may also be provided in the Movie (during the show and/or at the beginning or end) as desired. Therefore, it is to be appreciated that the present invention may utilize other Log Data analysis tools to provide any level of detail and/or information relating to the presentation of the Movie and user activity vis-à-vis a Web Site.

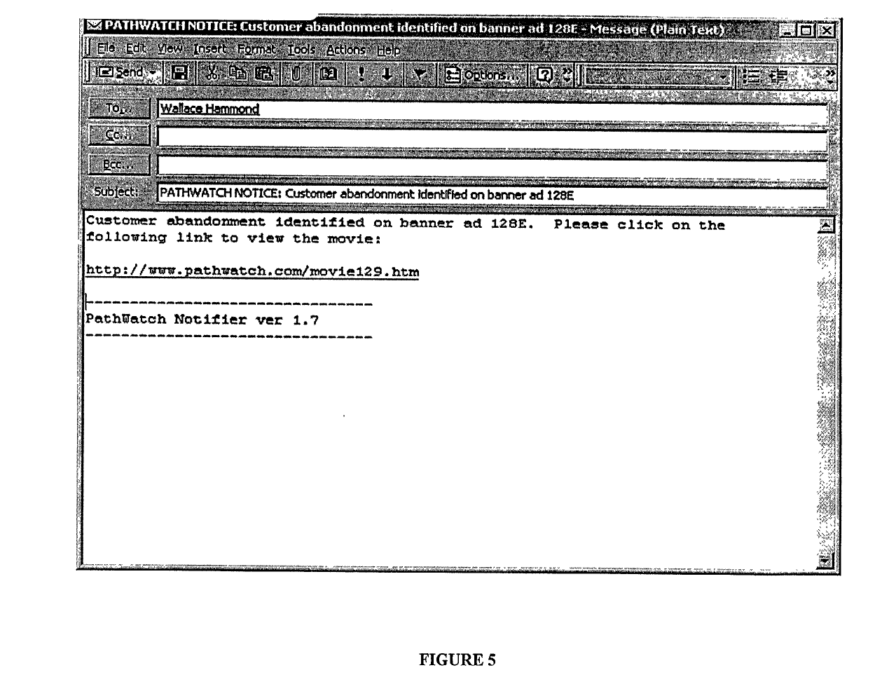

Additionally, the first embodiment facilitates the easy and effective distribution of a Movie to multiple Providers by attaching the Movie to an e-mail message (as shown in FIG. 5) which may be forwarded to other Providers as desired. As is well known in the art, various data compression and decompression algorithms and processes exist which enable one to communicate large quantities of data, as efficiently as possible, via an e-mail or other communications medium. The first embodiment of the present invention may utilize any and all such data transmission systems and methodologies in communicating a Movie to single and/or multiple users. Additionally, when the communication of a Movie in an e-mail message is undesirable (for example, due to system constraints, the size of the Movie file, or other variables), the present invention may also be configured to store the Movie on a server or data storage device accessible by the Provider (for example, via an Internet or other network connection).

In addition to providing an efficient and proven distribution system for a Movie, the email capabilities of the first embodiment also include adding Provider and event specific messages to such messages. For example, as shown in FIG. 5, the Provider may designate specific events, the happening of which on the Provider's Web Site (as captured in the Log Data) trigger the creation of a Movie. Instead of randomly providing the Movie, without any explanation of context, or requiring an operator to identify and communicate why a particular Movie was automatically generated, the first embodiment enables the Provider to establish predefined notification messages, routed to specific individuals, via various communications mediums (including, for example, e-mail, page, and telephone). Thus, the first embodiment of the present invention enables Providers to specify how, when, and in what format a notification message and/or a Movie will be provided by the system to the Provider and others.

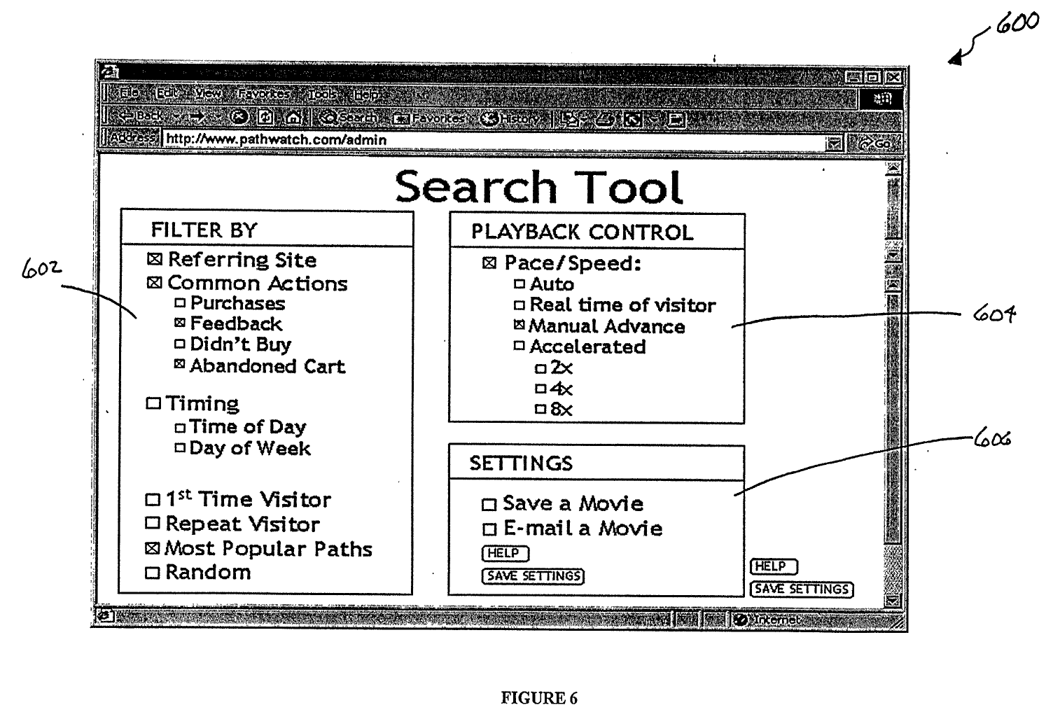

FIG. 6 provides one illustration of an application interface screen for a Filtering Administration Tool (as explained in greater detail below) used in the system of the first embodiment. This screen provides an interface through which a Provider specifies when Movies are to be generated, how played back, and when they are to be notified of the creation of such Movie. As shown, this screen 600 includes a field 602 in which the Provider may specify filtering conditions (the filter function of the present invention is discussed in greater detail below). Such filtering conditions include, but are not limited to, filtering based upon the referring site (i.e., from which site the user is contacting the web site of concern), by common actions (i.e., does the user purchase an item, provide feedback, not buy an item, or abandon a previously loaded shopping cart), by timing (i.e., the time of day and/or the day of the week), and by other variables (i.e., is the user a first time visitor, a repeat visitor, the most popular path utilized, and other variables). By appropriately specifying the filtering conditions the Provider may tailor the system such that the system reviews the Log Data and creates a Movie related to those aspects of a user's experience at a web site that the Provider is most concerned about. For example, a marketing person might request the system to generate a Movie based upon a given set of Log Data, such as the Most Popular Path utilized by an aggregate user. Such a Movie may enable the marketing person to identify those web pages a visitor is most likely to click through in reaching a destination and thereby design marketing and advertising features geared to such path (for example, pop-up windows that automatically appear advertising a product upon the selection of a web page along the most popular path).

This screen 600 also includes a field 604 in which a Provider may specify how a Movie is played back to them or others. More specifically, this feature enables the Provider to specify that the Movie will automatically be generated on a given display device (for example, a video monitor of a control center). This automatic viewing function might be very popular, for example, with system administrators who desire to receive an automatic movie whenever a hacker gains access to a secure site, thereby enabling the administrator to determine and close the portal through which the hacker gained access. The field 604 also enables the Provider to playback a Movie at varying speeds including, but not limited to, the real time rate for the visitor, on a manual advance setting, or on various accelerated rates. Other control features regarding the playback and presentation of the Movie may be added/deleted to this screen and others as desired.

As mentioned earlier herein, the first embodiment enables the Provider to specify how, when and where they are to be notified about a Movie. When a Movie is automatically generated, this notification control function may be extremely valuable because it enables Providers to continue with their day-to-day activities without concern as to whether the present invention is appropriately monitoring and screening the Log Data for events of interest and creating a corresponding Movie thereof. Further, in this first embodiment, the Provider may also specify the system to Save the Movie and/or E-Mail the Movie automatically or manually. Other functions may also be provided, as desired, with appropriate modifications to the interfaces, system and process flows.

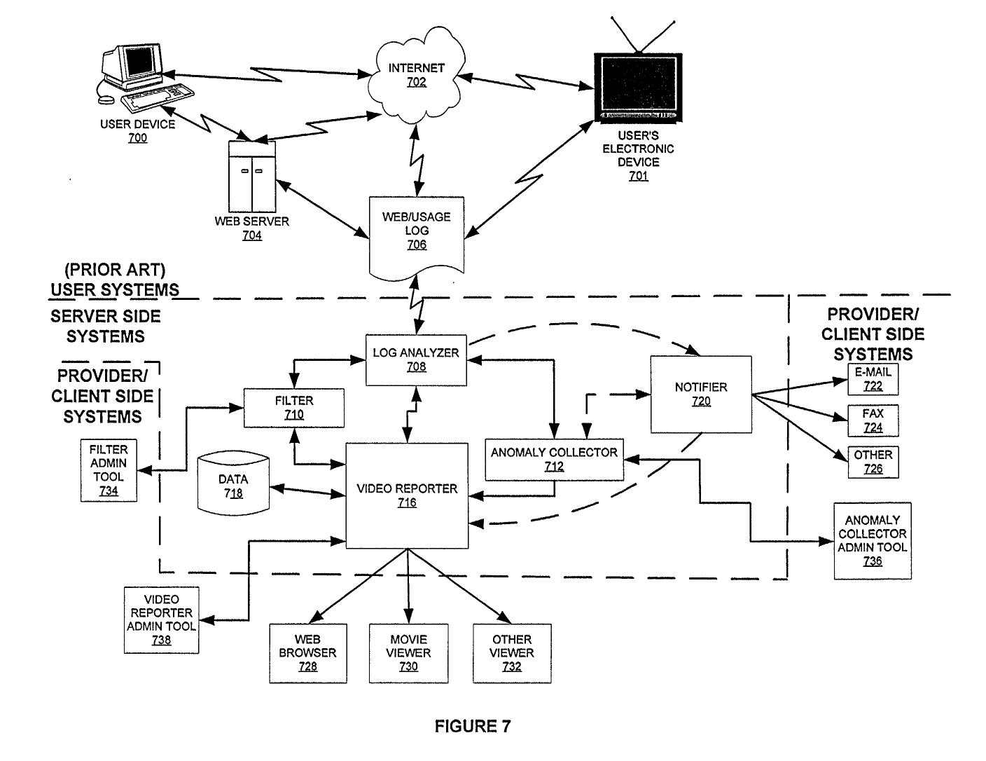

Referring now to FIG. 7, an embodiment of a system and a process by which the present invention provides a Movie to a Provider is illustrated. As shown the system is broken out into three segments. The first segment includes those User System segment components which are commonly used to generate Log Data. Also shown are Server Side system components, which are utilized to generate a Movie based upon Log Data. Lastly, Provider Side system components, which are commonly utilized by a Provider to receive and review a Movie, are depicted. Each of the components in these systems are described in greater detail herein below.

As shown and discussed previously, the system preferably utilizes web usage Log Data 706 to generate the Movie visualizing the user activity vis-a-vis the Web Site. In an Internet application of the present invention entries into the Log Data are preferably made every time a user device 700 is connected to a web server 704 via the Internet 702 or another direct/indirect connection. The collection of Log Data for such user connections is well known in the art. Additionally, it is to be appreciated that this embodiment may also be adapted to non-Internet applications, including one for applications and/or devices which are configured to record and/or utilize Log Data 706 collected for a Web Site (i.e., a web site, an application or an electronic device 701 (for example, a television)).

Regardless of how, when or where the Log Data 706 is gathered, compiled and/or stored, this embodiment suitably accesses such Log Data 706 and analyzes the data in the Log Analyzer 708. The Log Analyzer 708 is, in its most fundamental form, a user configurable analyzer that receives an inputted data stream and outputs a product of the analysis of the inputted data stream. In this case, the inputted data stream is generally a stream of Log Data provided, for example, by a web server. The Log Analyzer 708 may receive the stream of Log Data directly from a web server, from an intermediary (for example, a data storage device), or on a real-time basis, for example, when requests and information from a user are being provided to the web server a copy of such request, information, and the pages returned by the web server may simultaneously, or soon thereafter, be provided to the Log Analyzer. Additionally, the Log Analyzer 708 may be configured to access the Log Data 706 on a scheduled, intermittent, periodic, and/or as needed basis. It is to be appreciated that based upon how often, how much, how long, and the type of Log Data 706 analysis required for a given application, the Log Analyzer 708 may include or have access to numerous data storage devices, as needed, in order to process such Log Data.

Further, as shown in FIG. 7, the Log Analyzer 708 is in communication with a Filter 710, an Anomaly Collector 712, a Notifier 720, and a Video Reporter 716. The function of each of these components are described in greater detail below.

More specifically, the Log Analyzer 708 obtains analysis requests from either the Filter 710 and/or the Anomaly Collector 712. These requests direct the Log Analyzer 708 as to which Log Data 706 to obtain and for which patterns, events, or any other items of information the Log Analyzer is to search while the Log Analyzer 708 is reviewing the Log Data 706. As such, the Log Analyzer 708 performs those searching and filtering functions directed to it by the Filter 710 and/or the Anomaly Collector 712.

Additionally, when a request is received (from either the Filter 710 or the Anomaly Collector 712), the Log Analyzer 708 suitably obtains a relevant portion of the listings of a user's activities from the Log Data 706. It is to be appreciated that this listing may be as large or as small as desired. For example, a Provider (for example, a law enforcement officer) requesting a search for Log Data showing a user performing a specific illegal function might entail searching numerous days or even months worth of data. Similarly, a Provider requesting a search for users selecting a specific banner advertisement on a specific web site might utilize a Log Data file that is comparably small. Thus, the Log Analyzer 708 may analyze any quantity of information and based upon the results of such analysis, provide an output indicative thereof.

It is also to be appreciated that the output from the Log Analyzer 708 may significantly vary from request to request. However, in the first embodiment, the Log Analyzer 708 typically provides an output indicating a sequence of pages viewed (with unique URLs and date/time stamps for each page), a referring site, a browser type used, and any unique filters for the user visiting the site or application. These sequences of pages are preferably the data utilized by the Video Reporter 716 to create still frames that illustrate, in sequential order, those pages a user accessed while connected to a specific Web Site that generates the Log Data 706.

Additionally, in another embodiment, the output from the Log Analyzer 708 may also include “Fill-Ins”. Fill-Ins are information that is provided by the Log Analyzer 708 that is not physically present in the Log Data 706 but whose existence may be identified based upon an extrapolation of the first page and the subsequent pages a user viewed (or in the case of an electronic device, the first button pushed and a subsequent button pushed where, for example, an intermediate step was not recorded). One example of a Fill-In is a movement of a cursor across a web page to select a banner advertisement. Those skilled in the art appreciate that Log Data generally does not include cursor movement information. However, based upon the fact that a user was viewing page “x” and then a request to view a page associated with a banner advertisement was received by the web server and recorded the Log Data, the Log Analyzer can extrapolate the user's actions prior to selecting the banner advertisement (i.e., the user repositioned their cursor over the banner advertisement). Similarly, data provided in data entry fields (for example, a name and credit card number) may also be simulated in the Movie presented to the Provider using the Fill-In techniques of the third embodiment of the present invention.

As mentioned previously, the Log Analyzer 708 is preferably connected to both a Filter 710 and an Anomaly Collector 712. The Filter 710 provides an interface between the Log Analyzer 708 (i.e., the component actually accomplishing the filtering of the Log Data 706) and a Filtering Administration Tool 734. As discussed previously, an interface screen for the various embodiments of a Filtering Administration Tool is shown in FIG. 6 as the Search Tool. More specifically, the Filter 710 formats requests received from the Filtering Administration Tool 734 into a format desired by the Log Analyzer 708. Such requests preferably contain the name of the Provider that created the filter request, the criteria upon which to conduct the searching of the Log Data 706, when to run the search (i.e., when to filter the Log Data), and at what time periods the Log Analyzer 708 is to analyze, if at all, the resulting information provided from the filtering of the Log Data. It is to be appreciated that the time at which the filtering is conducted may be different than the time at which the analysis is conducted. For example, a filter request may direct the Log Analyzer to identify every user session wherein the user clicked on a banner advertisement. The same request may also direct the Log Analyzer to save the results of such filtering and at an appropriate time (for example, after 10 samples have been obtained) to analyze the filtered data using statistical analyses and other techniques. Additionally, the Tool 734 provides fields in which the Provider specifies how they are to be contacted when an anomaly occurs.

The Filter Administration Tool 734 provides an interface between the Provider and the Filter 710. More specifically, this Tool 734 provides templates, interface screens and other devices which enable the Provider to specify criteria for filtering requests of Log Data. This Tool 734 also allows a Provider to save requests and share requests with others as desired.

Referring still to FIG. 7, the Log Analyzer 708 is also connected to the Anomaly Collector 712. The Anomaly Collector 712 is similar in many aspects to the Filter 710 in that it directs the Log Analyzer 708 to analyze the Log Data 706 based upon specific criteria. However, unlike the Filter 710, the Anomaly Collector does not direct the Log Analyzer to search for instances of specific user activity. Instead, it directs the Log Analyzer to identify anomalous events (for example, when a user is suddenly booted from a web server due to a glitch in the system). In the first embodiment, the Anomaly Collector 712 directs the Log Analyzer 708 to search for anomalies every 30 minutes, however, other time periods may be utilized as desired.

When an anomaly occurs, the Anomaly Collector 712 is provided with an indication of the anomaly by the Log Analyzer 708. The Anomaly Collector 712 provides a message to the Notifier 720. This message preferably contains the name of the anomaly, the Provider account that needs to be notified, and any other information, as specified by the Provider via the Anomaly Collector Administration Tool 736.

The Anomaly Collector Administration Tool 736 provides an interface between the Provider and the Anomaly Collector 712. More specifically, this Tool 736 is similar to the Filter Admin Tool 734 in that it provides an application (e.g., software) and/or a device (e.g., hardware) upon which an interface may be presented to the Provider for specifying criteria used to detect an anomaly and the reporting thereof. When configured as an application, the Anomaly Collector Admin Tool 736 and the Filter Admin Tool 734 are generally hosted, for example, on a web browser on a compatible device (for example, a computer workstation, laptop computer, personal data assistant, web enabled wireless communications device, and other devices). The Tools 734 and 736 are preferably forms which capture user requests (for filtering and anomaly collecting, respectively). More specifically, the form for the Anomaly Collector Admin Tool 736 utilizes fields in which a Provider may specify a date (or time period) during which to perform the anomaly collecting and analysis, trigger events (for example, the number of times a banner advertisement is clicked or the number of users exiting a certain page), and threshold levels for trigger events. Additionally, the Tool 734 provides fields in which the Provider specifies how they are to be contacted when an anomaly event occurs.

Another component connected, either directly or indirectly, to the Log Analyzer 708 is the Video Reporter 716. The Video Reporter 716 is the component which receives those segments of the Log Data 706 identified by the Log Analyzer 708 as meeting a given set of filtering criteria and/or anomaly criteria. Upon receipt of the segments, the Video Reporter 716 converts such segments into a Movie. More specifically, as the Log Analyzer 708 identifies segments of the Log Data 706 (wherein a segment may be a single entry in the Log Data, a sequence of entries, a collection of entries, or an entire batch of entries), the segments are provided either directly or indirectly (i.e., through the Filter 710 and/or the Anomaly Collector 712) to the Video Reporter 716. The Video Reporter 716 utilizes the received segments to create the Movie.

As discussed above, the Movie may be presented in numerous formats, including, but not limited to, as a still image, as a sequence of still images, as a series of moving images, as statistical data with or without images, as a web page, and in other formats. Similarly, the Movie may be presented via any communications medium and/or signal format including digital, analog, satellite, cable, Internet, wireless mediums, radio frequency mediums, wired mediums, compressed, uncompressed, broadcast, MPEG format, DVD format, and any other mediums and/or formats. Further, any single enactment of a Movie may often be a unique presentation of images, graphics, text, audio, virtual reality, and/or other data formats. In order to create this presentation (i.e., the Movie), the Video Reporter suitably obtains a copy of any web pages or other information sites identified in the Segment. In order to simulate the condition of the web page as it was presented to the user, the Video Reporter suitably provides any data variables or other inputs necessary to configure the web page as a duplicate of that provided to and originally presented to the user. However, appropriate security protections are provided in the Video Reporter so that confidential information (for example, a user's credit card number) may be masked as necessary.

Further, upon obtaining any web pages or other information, the Video Reporter 716 formats the data such that it is compatible with a viewing device specified by the Provider. A Video Reporter Admin Tool 738 preferably provides an interface between the Provider and the Video Reporter. As provided for the other Tools 734 and 736, the Video Reporter Admin Tool 738 provides those templates upon which the Provider may specify the format (and other variables) in which a Movie is to be presented. Additionally, this Tool 738 includes a search interface which enables the Provider to specify specific Movies for presentation, such Movies being saved in and retrieved from a Data storage device 718 automatically and/or upon a Provider's instruction.

For example, a Provider may request a search for “all movies involving visitors to Amazon.com” or to “show all movies from Jan. 17, 2000 between 8:00 am and 9:00 am MST.” The Tool 738 initiates a search by the Video Reporter 716 of the appropriate Data storage devices 718 or other archives for all relevant Movies. Such searching is accomplished via standard database queries. Further, the Movies and indexes thereof may be suitably stored in a relational database, object based database, or other database structure. The storage and retrieval of information in/from all types of databases is well known in the art.

The first embodiment also provides a Notifier 720. The Notifier performs the function of sending notification messages to the designated Provider(s). Preferably, such notification messages are sent via e-mail 722, however, other messaging formats and protocols including faxes 724 and other communications mediums 726 (for example, telephones, pagers, personal data assistants and other wireless or wired devices) may be utilized. A typical message (as shown above in FIG. 5 for an e-mail message) contains the following information: the name of the recipient of the notification message, the date and time of the event, the name of the event, and a hyperlink (when possible) to direct the Provider to the data file containing the Movie. More or less information may be provided in a message as particular needs and communications mediums dictate. As discussed previously, the Notifier 720 may also be configured to e-mail a notification to multiple individuals, as desired. Additionally, when a message is generated, such message may be forward to other users as desired and as is common in the art.

The final component of the system is the device upon which the client views the Movie. Such devices are represented in FIG. 7 by the Web Browser 728, the Movie Viewer 730 (which may stream media), and the Other Viewers 732. When the Provider configures the Video Reporter 716, via the Video Reporter Admin Tool 738, a designation is made of the type(s) of viewer upon which the Provider desires to view a given Movie. It is to be appreciated that a Provider may request a Movie to be presented in any format and/or number of formats. As such, the present invention is Provider device neutral as the configuration of the Movie is determined by the Video Reporter 716 prior to transmission to the Provider. In this regard, any device(s) capable of presenting a given type of data may be utilized by the Provider. Similarly, multiple instances of a Movie may be provided (simultaneously or separately) to various types of viewing devices.

For example, in an electronic device (or appliance) embodiment, a Provider might be a service technician who suitably downloads from the electronic device in question a Log Data file which has recorded a given amount of time prior to a given event (for example, the malfunctioning of the electronic device). This information, after being appropriately filtered and/or analyzed, may be presented in the format of a Movie. Additionally, the Movie may be configured for presentation on a type of device specified by the Provider (for example, a computer lap top or a personal data assistant). Additionally, the system may be directed to present such information in a format useful to the Provider. For example, a service technician may desire to see various scenes depicting the operating state of the electronic device in question prior to, at the time of, and after the malfunction. Such scenes in the Movie may include, for example, a clocking diagram of a bus controller, a series of user actions (for example, a series of buttons pressed by the user), and/or an indication of any alarm signals or messages generated by the electronic device. However, in order to present such scenes in a Movie, it is to be appreciated that the electronic device must create a Log Data file with sufficient information to recreate such information directly or by using a Fill-In.

Additionally, the various embodiments of the present invention enable the Movie to be presented to the Provider in at least two formats (other formats, for example, an audio format, may also be provided). The two preferred formats are as either a web page presented on a Web Browser 728 or as a data file presented on an application specific Other Viewer 732 (for example, one similar to a Napster music viewer that does not run directly on a web browser and is instead a stand alone application). Other formats may also be utilized as such formats become commonly available. When the Web Browser approach is utilized, the Movie is presented directly in the browser via common approaches such as a GIF image on the Web Browser 728, or a video stream in a web browser based application such as a RealVideo® Player, Windows Media Player®, or Apple QuickTime® on the Movie Viewer 730.

When the Movie is presented via the Other Viewer 732, a stand alone application is deployed to all Providers. The stand alone application preferably connects to other components of the system using standard Internet protocols (e.g., TCP/IP) without requiring the use of a browser. As is commonly appreciated, such an application can be written in various languages including, but not limited to, C++, VisualBasic, and Java.

Regardless of the specific embodiment of client viewer utilized, the viewer preferably allows the Provider to control the speed of playback, and other parameters (as discussed above in reference to FIG. 5). The Movie files may also be annotated, cut, pasted, copied, and similarly manipulated using commonly available functions.

As such, the before mentioned embodiments of the present invention provides a system and process for creating a visual or other representation of user activity. As discussed above, the present invention utilizes various components, some of which are commonly available. However, it is to be appreciated that the foregoing embodiments of the present invention are not limited to any specific networks, communications mediums, platforms (including, for example, Windows, Unix, and Macintosh), or protocols. Further, the various embodiments of the present invention may utilize any communication paths, file types, applications, components, devices, protocols, and the like to provide the features and functions identified herein and set forth in the claims. Thus, the various embodiments of the present invention may be utilized to “visualize” (which is herein defined to include any human perceptible signal including, but not limited to audio, video, and tactile signals) or user activity for any Web Site regardless of the communications paths utilized by the user, the format of the data accessed, the presentation device utilized to present the visualization, and any other variable or factor to create and present a Movie.

1. A system for generating a Movie presenting a recreation of a utilization of at least one Web Site based upon log data, comprising:
a log analyzer which receives and analyzes log data, wherein the log data comprises information relating to a utilization of at least one Web Site; and
a video reporter, connected to the log analyzer, which receives a result of the analysis of the log data from the log analyzer and converts the result into a Movie presenting a recreation of the utilization of the at least one Web Site;
wherein a provider uses the Movie to determine how the at least one Web Site is utilized.

2. The system of claim 1, wherein the log analyzer analyzes the log data based upon at least one request received from at least one of a filter and an anomaly collector.

3. The system of claim 2, wherein the request directs the log analyzer to search and extract from the log data instances of specific utilizations of the at least one Web Site.

4. The system of claim 2, wherein the request directs the log analyzer to identify anomalous events related to utilization of the at least one Web Site.

5. The system of claim 1, wherein the Web Site further comprises at least one device.

6. The system of claim 1, wherein the result of the analysis indicates a sequence of web pages viewed by a user during a given user session with a Web Site for which the log data was collected.

7. The system of claim 6, wherein the sequence of web pages are converted by the video reporter into still frames that illustrate those web pages a user accessed while utilizing the Web Site.

8. The system of claim 7, further comprising at least one of a web browser, a movie viewer and an other viewer which enables a provider to control the presentation of the still frames.

9. The system of claim 1, further comprising a notifier which notifies a provider when a Movie has been generated.

10. The system of claim 1, wherein the Movie comprises at least one of an audio, video and combined audio/video signal that may be presented to the provider.

11. The system of claim 1, wherein the log analyzer accesses multiple log data files and utilizes at least one statistical tool to perform at least one statistical analysis upon the accessed multiple log data files and provides a result thereof.

12. The system of claim 11, wherein the result of the statistical analysis is provided to the provider as an addition to the Movie.

13. A system for generating a Movie providing a recreation of at least one user's utilization of at least one Web Site, comprising:
a log analyzer which receives and analyzes a log data file based upon at least one criteria;
at least one of a filter and an anomaly collector, in communication with the log analyzer, which provide the at least one criteria to the log analyzer;
a video reporter, in communication with the log analyzer, which receives an output from the log analyzer and creates a Movie, the Movie providing a recreation of at least one user's utilization of at least one Web Site; and
at least one of a web browser and a viewer, in communication with the video reporter, for presenting the Movie to a provider via a presentation device.

14. The system of claim 13, wherein the system further comprises a filter administration tool which provides at least one interface screen by which a provider specifies the at least one criteria for filtering the log data.

15. The system of claim 13, wherein the system further comprises an anomaly collector administration tool which provides an interface by which a provider specifies the at least one criteria as comprising at least one of a time and date range, trigger events, and threshold levels for the trigger events.

16. The system of claim 15, wherein the anomaly collector administration tool further comprises an interface by which a provider specifies how the provider is to be contacted when a trigger event occurs.

17. The system of claim 16, wherein the system further comprises a notifier which provides an email notification to the provider when a trigger event occurs.

18. The system of claim 13, wherein the system further comprises at least one data storage device, connected to the video reporter, for storing at least one movie created by the video reporter.

19. The system of claim 18, wherein the system further comprises a video reporter administration tool which further comprises an interface by which a provider may request a search for at least one movie stored in the at least one data storage device.

20. A system for generating log data utilized to generate a Movie depicting a recreation of at least one user's utilization of a Web Site, comprising:
a server, connected to a network connection, providing a Web Site utilized by a user; and
a database, connected to the server, containing at least one entry of log data compiled by the server as the user accessed the Web Site;
wherein the log data is utilized to generate a Movie depicting a recreation of at least one user's utilization of the Web Site; the Movie being utilized by a provider to analyze the user's utilization of the Web Site.

21. A method for generating from log data a recreation of at least one utilization of at least one Web Site, comprising:
obtaining log data, wherein the log data comprises at least one element of information relating to at least one utilization of at least one Web Site;
analyzing the log data; and
converting a result of the analyzing of the log data into a Movie providing a recreation of the at least one utilization of the at least one Web Site;
whereupon reviewing the Movie, a provider can determine how the at least one Web Site was utilized by at least one user.

22. The method of claim 21, wherein the Movie further comprises at least one of an audio signal, a video signal, and a combined audio/video signal.

23. The method of claim 21, wherein the obtaining log data further comprises receiving at least one request for an analysis of log data from at least one of a filter and anomaly collector, wherein the request specifies from where to obtain the log data and at least one criteria to apply to the log data in generating the result.

24. The method of claim 23, wherein the at least one request specifies a search of the log data for instances of specific utilizations of the at least one Web Site.

25. The method of claim 23, wherein the at least one request specifies an identification of anomalous event related to the utilization of the at least one Web Site.

26. The method of claim 25, wherein the method further comprises notifying a provider when the anomalous event is identified.

27. A system for generating a visualization of a user's utilization of a Web Site comprising:
a means for analyzing log data, wherein the log data comprises information relating to a utilization of a Web Site by at least one user; and
a means for converting a result, provided by the means for analyzing log data, into a Movie presenting a recreation of the utilization of the Web Site by the at least one user.

28. The system of claim 27, wherein the system is provided via a web server.

29. The system of claim 27, further comprising a means for filtering the log data, wherein the means for filtering generates a request to the log analyzer to identify instances of specific utilizations of the web site as a filter event.

30. The system of claim 29, further comprising a means for collecting anomalies, wherein the means for collecting anomalies generates a request to the log analyzer to identify at least one anomalous event related to utilization of the Web Site.

31. The system of claim 30, further comprising a means for notifying a provider when at least one of the Movie, the filter event, and the anomalous event occur.

32. The system of claim 31, further comprising a means for presenting the Movie connected to the means for converting a result into a Movie.

33. The system of claim 32, further comprising a means for storing a Movie connected to the means for converting a result into a Movie.

34. The system of claim 33, further comprising a means for identifying at least one search criteria for retrieving at least one Movie stored in the means for storing a Movie.
